(19) United States
(12) Patent Application Publication
(10) Pub. No.: US 2017/0140440 A1
(43) Pub. Date: May 18, 2017

(54) SYSTEMS AND METHODS FOR DETERMINING AND PROVIDING ADVERTISEMENT RECOMMENDATIONS

(71) Applicant: Facebook, Inc., Menlo Park, CA (US)

(72) Inventors: Bharathy Sripadham, Menlo Park, CA (US); Abhishek Rudresh, Sunnyvale, CA (US); Sharon Sason Aspir, Sunnyvale, CA (US); Richard Dunham Hislop, Menlo Park, CA (US)

(21) Appl. No.: 14/939,578

(22) Filed: Nov. 12, 2015

(51) Int. Cl. G06Q 30/02

(52) U.S. Cl. CPC G06Q 30/0277; G06Q 30/0246; G06Q 50/01

(57) ABSTRACT

Systems, methods, and non-transitory computer-readable media can receive an advertisement rule. An eligible advertiser is determined based on the advertisement rule. An advertisement recommendation is determined for the eligible advertiser based on the advertisement rule. The eligible advertiser is monitored for conversion status information.

### FIELD OF THE INVENTION

The present technology relates to the field of social networks. More particularly, the present technology relates to determining and providing advertisement recommendations.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Advertisers can advertise to users on the social networking system. Ad-related products offered by the social networking system can be offered to advertisers to more effectively advertise to users on the social networking system. The effectiveness of advertisements on the social networking system can be enhanced as the social networking system becomes more knowledgeable about users and advertisers that it serves. This information can be leveraged by the social networking system to optimize products and services offered to both users and advertisers.

### SUMMARY

Various embodiments of the present disclosure can include systems, methods, and non-transitory computer readable media configured to receive an advertisement rule. An eligible advertiser is determined based on the advertisement rule. An advertisement recommendation is determined for the eligible advertiser based on the advertisement rule. The eligible advertiser is monitored for conversion status information.

In an embodiment, the advertisement recommendation is ranked among a plurality of advertisement recommendations based on recommendation ranking criteria.

In an embodiment, each advertisement recommendation is associated with a recommendation priority score.

In an embodiment, the ranking the advertisement recommendation among a plurality of advertisement recommendations based on recommendation ranking criteria comprises ranking the advertisement recommendation among a plurality of advertisement recommendations based on the recommendation priority score.

In an embodiment, the recommendation priority score is based on an expected monetary value calculation.

In an embodiment, the expected monetary value calculation comprises the product of a probability of adoption and an expected spend amount.

In an embodiment, the expected spend amount is based on a twenty-eight day spend.

In an embodiment, conversion data associated with the advertisement recommendation is updated based on the conversion status information.

In an embodiment, updating conversion data associated with the advertisement recommendation based on the conversion status information comprises crediting the advertisement recommendation for a particular advertiser action if the particular advertiser action takes place within a pre-determined period of time after the advertiser is presented with the advertisement recommendation.

In an embodiment, the advertisement recommendation comprises a recommendation for an ad-based product offered by a social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an advertiser relationship management module, according to an embodiment of the present disclosure.

FIG. 2 illustrates an example advertisement recommendation module, according to an embodiment of the present disclosure.

FIG. 3 illustrates an example scenario including an example advertisement recommendation interface, according to an embodiment of the present disclosure.

FIG. 4 illustrates an example method for providing advertisement recommendations, according to an embodiment of the present disclosure.

FIG. 5 illustrates an example method for determining and ranking advertisement recommendations, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Social Network Advertisement Recommendations

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (i.e., a social networking service, a social network, etc.). For example, users can add friends or contacts, provide, post, or publish content items, such as text, notes, status updates, links, pictures, videos, and audio, via the social networking system.

Advertisers can reach users of a social networking system by posting content, including advertisements, and interacting with users on the social networking system. As users and advertisers interact on the social networking system, the system receives and stores more information and learns more about the users and advertisers that it serves. Information on interactions between users and advertisers can be leveraged by the social networking system to optimize the presentation of relevant advertising and services to both users and advertisers. Ad-related products can be offered to an advertiser to increase the effectiveness of the advertiser's advertisements on the social networking system.

It continues to be an important interest for a social networking system rooted in computer technology to maximize the effectiveness of advertisements on the social networking system. However, it can be difficult to analyze available information to effectively provide recommendations to advertisers as to how to increase the effectiveness of their advertisements on the social networking system. This is particularly true given that it is often the case that a relatively small number of customer support members are servicing a relatively large number of advertisers. As such, even if ad-related products are available to increase the effectiveness of advertisements, it can be difficult to efficiently determine which ad-related products would benefit each advertiser.

Therefore, an improved approach can be beneficial for overcoming these and other disadvantages associated with conventional approaches. Based on computer technology, the disclosed technology can receive one or more advertisement rules based on observed or collected information. One or more advertisement recommendations can be made for an advertiser based on the one or more advertisement rules. The one or more advertisement recommendations can be provided to a customer support member for presentation to the advertiser, or provided directly to the advertiser. Recommendation ranking criteria may be utilized to rank advertisement recommendations. The advertiser's subsequent actions can be monitored for conversion status information. The conversion status can be utilized to update conversion data for the advertisement recommendation.

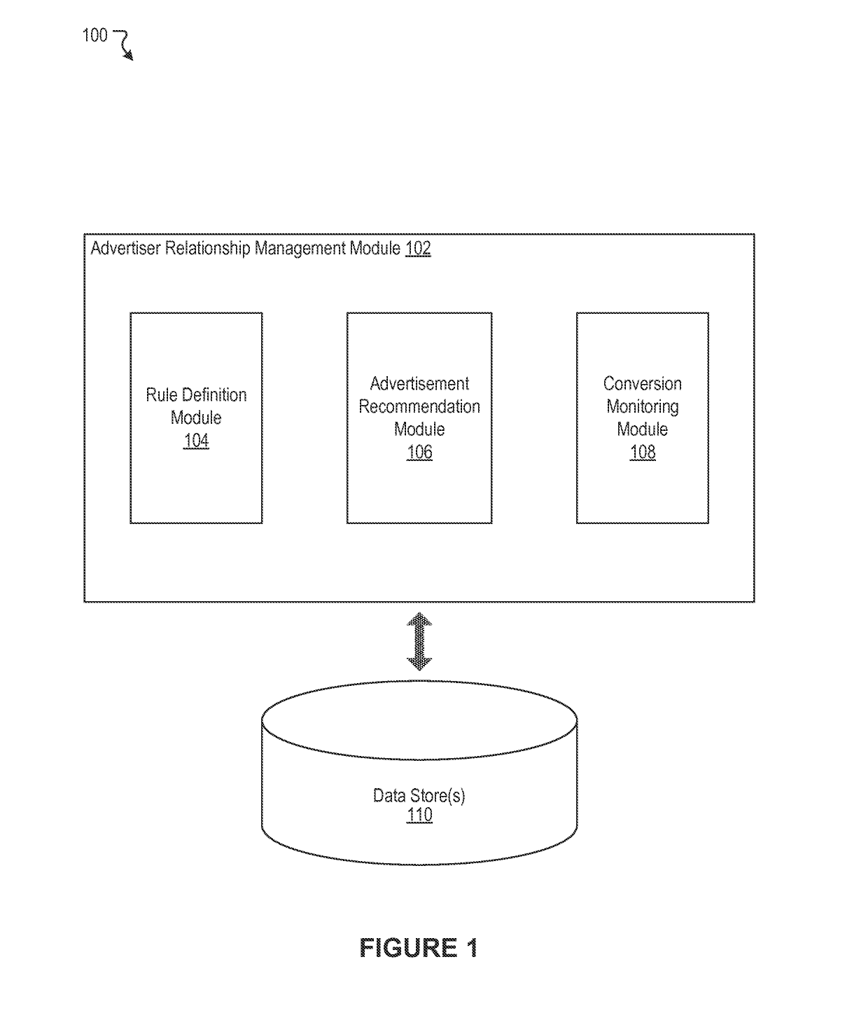

FIG. 1 illustrates an example system 100 including an example advertiser relationship management module 102 configured to facilitate providing advertisement recommendations, according to an embodiment of the present disclosure. The advertiser relationship management module 102 can be configured to receive one or more advertisement rules and to determine one or more advertisement recommendations for one or more advertisers based on the one or more advertisement rules. Eligibility of an advertiser for a particular advertisement recommendation can be determined based on an advertisement rule. The advertiser relationship management module 102 may be further configured to rank advertisement recommendations for an advertiser based on recommendation ranking criteria. The advertiser relationship management module 102 can be configured to monitor advertiser behavior for conversion status information to update a particular advertisement recommendation's conversion data.

As shown in the example of FIG. 1, the advertiser relationship management module 102 can include a rule definition module 104, an advertisement recommendation module 106, and a conversion monitoring module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

The rule definition module 104 can be configured to receive one or more advertisement rules. Advertisement rules can be defined based on insights, data, or other information gathered regarding users and advertisers on a social networking system. An advertisement rule can define how advertisement recommendations are provided to advertisers. For example, an advertisement rule might be defined such that every advertiser that has not used a video advertisement receives a recommendation to use video advertisements. In another example, an advertisement rule might be defined such that every advertiser that has a mobile application receives a recommendation to use a “mobile application install” advertisement that allows a user to install the advertiser's mobile application by interacting with the advertisement.

In certain embodiments, each advertisement rule can include eligibility criteria and call to action information. The eligibility criteria can define which advertisers are eligible to receive an advertisement recommendation based on the advertisement rule, i.e., eligible advertisers. For example, in the video advertisement example provided above, eligible advertisers could include all advertisers that have not used video advertisements. The call to action information can define an advertisement recommendation to be provided to eligible advertisers. For example, in the example provided above, the call to action information could indicate that eligible advertisers, i.e., advertisers who have not used video advertisements, should receive an advertisement recommendation to use video advertisements.

An advertisement rule, or an advertisement recommendation based on the advertisement rule, can also include conversion data. The conversion data can include information indicative of the rate at which advertisers take action based on the advertisement recommendation specified by the call to action information. In the video advertisement example provided above, the conversion data can include information indicative of how often advertisers actually go on to use a video advertisement after they receive the advertisement recommendation to use video advertisements. In certain embodiments, an advertisement recommendation can be credited with a corresponding recommended action taken by an advertiser if the corresponding recommended action is taken by the advertiser within a pre-determined period of time after the advertiser receives the advertisement recommendation. For example, if an advertiser takes a recommended action within 28 days of receiving an advertisement recommendation, then the advertisement recommendation can be credited with the advertiser taking the recommended action. In this case, the conversion data can include information indicative of how often advertisers take a recommended action within the pre-determined period of time after receiving an advertisement recommendation.

The advertisement recommendation module 106 can be configured to determine one or advertisement recommendations based on an advertisement rule. The advertisement recommendation module 106 can be configured to receive an advertisement rule from the rule definition module 104, and to determine which advertisers are eligible to receive an advertisement recommendation based on the eligibility criteria specified by the advertisement rule. The advertisement recommendation module 106 can be configured to provide an advertisement recommendation for any eligible advertisers based on the call to action information specified by the advertisement rule. The advertisement recommendation module 106 can also be configured to rank one or more advertisement recommendations. A user can be presented with a ranked list of advertisement recommendations. Users may include customer support members, who could then present any advertisement recommendations to advertisers (i.e., customers). Users may also include advertisers themselves, who could then take direct action based on the one or more advertisement recommendations. The ranked list of advertisement recommendations can be filtered based on recommendation filtering criteria. For example, the list of advertisement recommendations may be filtered to show only advertisement recommendations for a particular advertiser, or a particular advertising campaign. The advertisement recommendation module 106 is discussed in greater detail herein.

The conversion monitoring module 108 can be configured to monitor and track advertiser actions to determine conversion status information. The conversion status of a particular advertisement recommendation can be an indication of whether or not an advertiser has taken a recommended action based on the advertisement recommendation. The conversion status can be used to update conversion data for the advertisement recommendation. As discussed above, conversion data can be indicative of how often advertisers take a particular action after receiving an advertisement recommendation. Conversion data can be utilized to estimate how likely it is that a particular advertisement recommendation will lead to a desired action. Conversion data can be useful, for example, in ranking advertisement recommendations, as those advertisement recommendations with a greater likelihood of adoption may be ranked higher than those with a lower likelihood. As discussed previously, a particular advertisement recommendation can be credited with a corresponding recommended action if an advertiser takes the recommended action within a pre-determined period of time after having received the advertisement recommendation. The pre-determined period of time can vary based on the advertisement recommendation. For example, a first advertisement recommendation may include a 14-day monitoring period, whereas another advertisement recommendation may include a 28-day monitoring period.

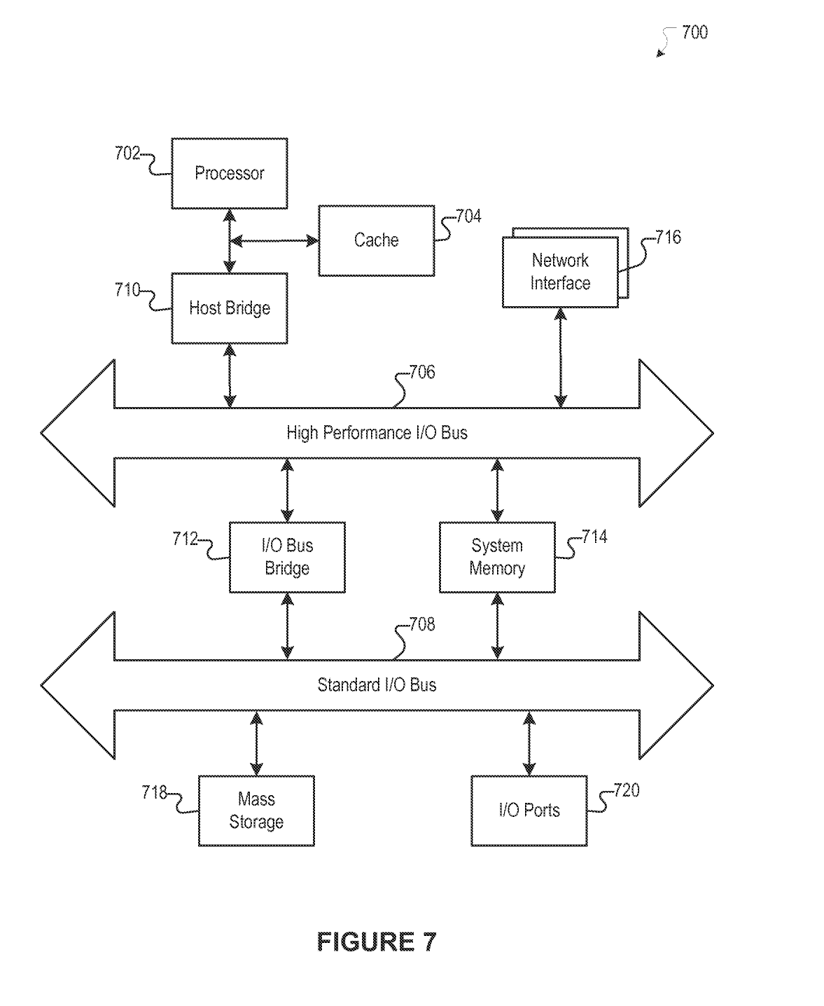

The advertiser relationship management module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the advertiser relationship management module 102 can be implemented, in part or in whole, as software running on one or more computing devices or systems, such as on a server computing system or a user (or client) computing system. For example, the advertiser relationship management module 102 or at least a portion thereof can be implemented as or within an application (e.g., app), a program, or an applet, etc., running on a user computing device or a client computing system, such as the user device 710 of FIG. 7. In another example, the advertiser relationship management module 102 or at least a portion thereof can be implemented using one or more computing devices or systems that include one or more servers, such as network servers or cloud servers. In some instances, the advertiser relationship management module 102 can, in part or in whole, be implemented within or configured to operate in conjunction with a social networking system (or service), such as the social networking system 730 of FIG. 7. It should be understood that there can be many variations or other possibilities.

The advertiser relationship management module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 730 of FIG. 7). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the advertiser relationship management module 102. For instance, the data store 110 can store advertisement rule information, advertiser eligibility criteria, call to action information, conversion data, advertisement history information, and any other information that may be used to carry out the present technology disclosed herein. It is contemplated that there can be many variations or other possibilities.

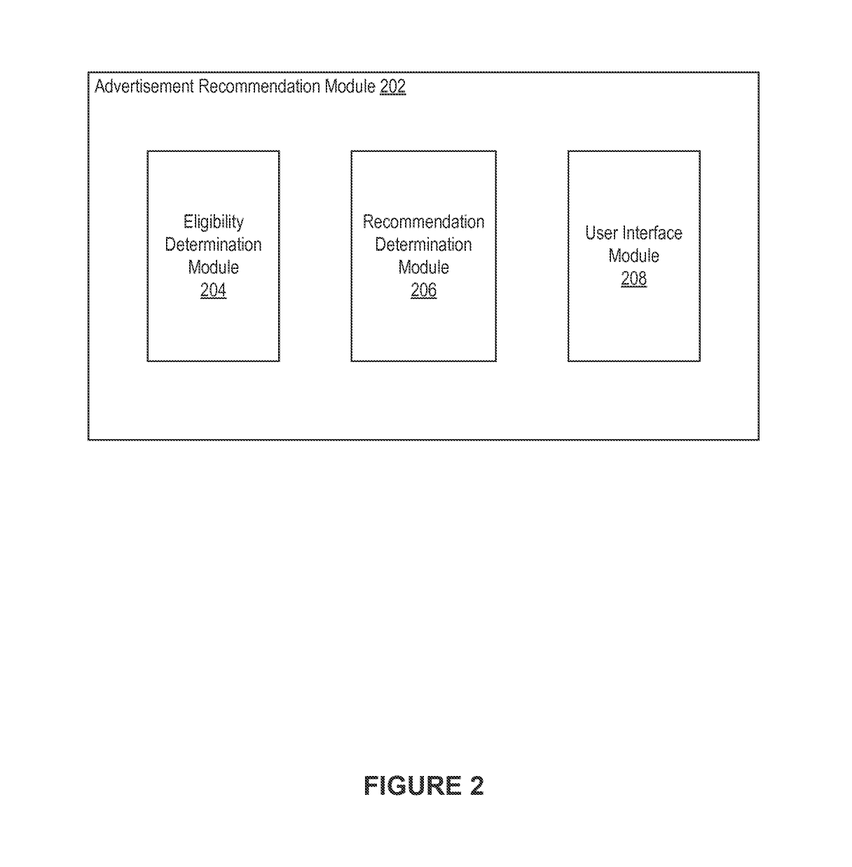

FIG. 2 illustrates an example advertisement recommendation module 202 configured to provide advertisement recommendations based on advertisement rules, according to an embodiment of the present disclosure. In some embodiments, the advertisement recommendation module 104 of FIG. 1 can be implemented as the example advertisement recommendation module 202. As shown in FIG. 2, the advertisement recommendation module 202 can include an eligibility determination module 204, a recommendation determination module 206, and a user interface module 208.

The eligibility determination module 204 can be configured to determine one or more eligible advertisers based on one or more advertisement rules. For example, the eligibility determination module 204 can be configured to utilize eligibility criteria defined by a particular advertisement rule and apply it to all advertisers of a social networking system. The eligibility determination module 204 can determine which advertisers are “eligible” to receive an advertisement recommendation based on the particular advertisement rule. Eligibility criteria can be defined to capture advertisers that may benefit from a particular advertisement recommendation. In certain embodiments, a single advertiser may have multiple advertising campaigns. Rather than eligibility criteria identifying a particular advertiser, eligibility criteria may be used to identify eligible advertising campaigns. For example, an example was previously discussed in which all advertisers who have not used video advertising receive a recommendation to use a video advertisement. Rather than identifying advertisers that have not used video advertising, eligibility criteria can be utilized to identify all advertising campaigns that have not used video advertising. In this way, if a particular advertiser has used video advertising in a first campaign, but not in a second campaign, the second campaign can be identified as an eligible campaign, and the advertiser can receive a recommendation to use video advertising in the second campaign.

Eligibility criteria can be applied using information that is gathered by a social networking system about a particular advertiser (or advertising campaign) or that is provided by an advertiser. For example, in the video advertising example discussed above, the social networking system could determine, based on information available to it, that a particular advertiser has not used video advertising. In another example, an advertiser can explicitly state its advertising goals. This information provided by the advertiser, as well as information that can be inferred from the provided information, can be used in determining eligibility for advertisement recommendations. For example, if an advertiser indicates that one of its goals is to get users to use the advertiser's mobile application, the eligibility determination module 204 can be configured to understand or infer that the advertiser has a mobile application, and to recommend advertisement recommendations for which the eligibility criteria includes advertisers that have a mobile application.

The recommendation determination module 206 can be configured to provide advertisement recommendations for eligible advertisers based on one or more advertisement rules. As discussed above, an advertisement rule can include call to action information. An advertisement recommendation for an eligible advertiser can be determined based on the call to action information. For example, if an advertisement rule dictates that all advertisers who have not used video advertising should receive a recommendation to use video advertising, the eligibility criteria would include all advertisers who have not used video advertising, and the call to action information would include providing an advertisement recommendation to use video advertising. The recommendation determination module 206 can be configured to use this information to create an appropriate advertisement recommendation for eligible advertisers.

The user interface module 208 can be configured to provide a user interface to present advertisement recommendations. As discussed previously, advertisement recommendations can be presented to a customer support member, who could then suggest any applicable advertisement recommendations to advertisers. Advertisement recommendations could also be presented directly to advertisers. In certain embodiments, the user interface module 208 can be configured to rank advertisement recommendations based on ranking criteria, so as to present a ranked list of advertisement recommendations. In certain embodiments, each advertisement recommendation can be assigned a recommendation priority score, and ranked based on the recommendation priority score. The recommendation priority score can be based on an expected monetary value calculation. For example, the recommendation priority score can be based on a product of a probability of adoption of the advertisement recommendation and an expected spend by the advertiser. The probability of adoption can be based on conversion data for the advertisement recommendation, e.g., the rate at which previous advertisers who have been presented with the same or a similar advertisement recommendation have adopted the recommended action. The expected spend by the advertiser can be based on previous spending information, such as a 28-day spend, i.e., the amount spent in the previous 28-day period. In another embodiment, the expected monetary value can be determined by multiplying a probability of adoption for an advertisement recommendation by an average financial impact of adoption, and scaling appropriately for a particular advertiser. The probability of adoption can be determined based on conversion data. The average financial impact of adoption can be determined by analyzing financial data for advertisers who have previously adopted the same or a similar advertisement recommendation. For example, an advertiser's spending data before and after adoption of the recommended action can be analyzed to determine an expected financial impact of adoption.

In certain embodiments, the user interface module 208 can be configured to filter advertisement recommendations based on recommendation filtering criteria. For example, a customer support member may service multiple advertisers, and may be able to see advertisement recommendations for multiple advertisers at once, or an advertiser may have multiple advertising campaigns. Filtering criteria could be applied to display only advertisement recommendations for a particular advertiser or a particular advertising campaign. In another example, advertisement recommendations can be filtered based on ranking or priority score, for example, to show only those advertisement recommendations that satisfy a minimum ranking or minimum priority score threshold.

Much like advertisement recommendations can be ranked based on recommendation ranking criteria and filtered based on recommendation filtering criteria, advertisers (or advertising campaigns) can be ranked based on advertiser ranking criteria or filtered based on advertiser filtering criteria. Similar to the way users can view a filtered, ranked list of advertisement recommendations, a user can also be presented with a filtered, ranked list of advertisers (or advertising campaigns). This may be useful, for example, for a customer support member so that the customer support member can see which advertisers potentially have the most to gain from advertisement recommendations, and can prioritize contacting the various advertisers accordingly. In certain embodiments, an advertiser's (or advertising campaign's) advertiser priority score can be determined by summing the recommendation priority scores of each advertisement recommendation available for that advertiser (advertising campaign).

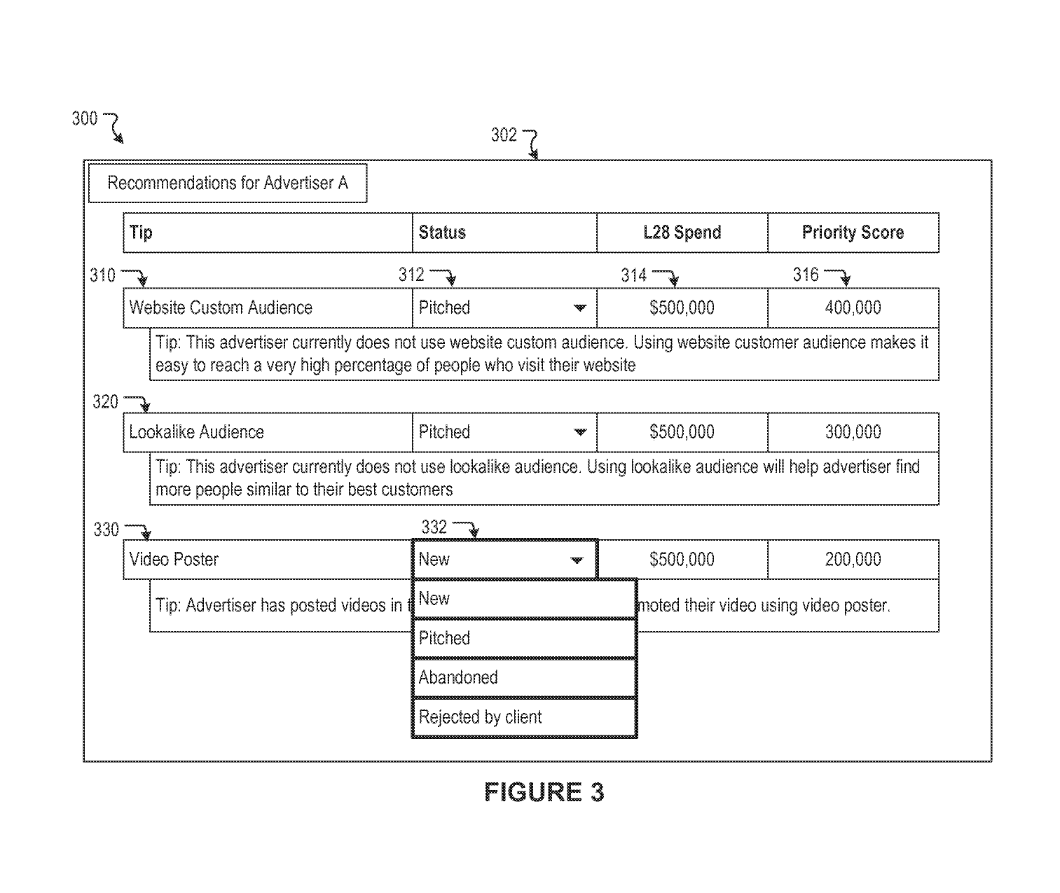

FIG. 3 illustrates an example scenario 300 associated with providing advertisement recommendations, according to an embodiment of the present disclosure. The example scenario 300 illustrates an example interface 302 for providing advertisement recommendations. As shown in FIG. 3, the example interface 302 presents a list of advertisement recommendations 310, 320, 330 for an advertiser “Advertiser A.”

A first advertisement recommendation 310 is titled “Website Custom Audience,” and includes a status 312. In the example scenario 300, the status 312 is implemented as a drop down menu with several selections available to the user (see, e.g., the drop down menu shown for status note 332). When an advertisement recommendation is first presented for a particular advertiser, the status can be set to “New.” Once the user has pitched the advertisement recommendation to the advertiser, the user can change the status to “Pitched.” Once the status is set to “Pitched,” a clock may begin running for the advertisement recommendation in order to keep track of conversion status, e.g., whether the pitch resulted in adoption by the advertiser within a pre-determined period of time. The status may be set to “Abandoned” if it is determined, for example, by a customer support member, that the application recommendation is not appropriate for the advertiser. The status may be set to “Rejected by client” if the advertiser has indicated that it does not wish to take the action recommended by the application recommendation.

Each advertisement recommendation 310, 320, 330 is ranked based on a recommendation priority score, labeled “Priority Score” in FIG. 3. As discussed above, in this example, the recommendation priority score is calculated by multiplying a 28-day spend (labeled “L28 Spend”) with a probability of adoption. The probability of adoption is calculated based on conversion data. For example, the advertisement recommendation 310 (“Website Custom Audience”) has a priority score of 400,000, which was calculated by multiplying the L28 Spend (“$500,000”) by a conversion rate of 0.8. The conversion rate of 0.8 indicates that of previous advertisers who have been presented with the same advertisement recommendation, 80% have adopted the recommended action. Conversion data for an advertisement recommendation can be updated as the advertisement recommendation is provided to additional advertisers, and those advertisers' behaviors are monitored to track whether or not they have adopted the action recommended by the advertisement recommendation.

FIG. 3 includes several examples of advertisement recommendations based on ad-based products that may be available to advertisers. For example, advertisement recommendation 310 is labeled “Website Custom Audience.” This advertisement recommendation could apply to all advertisers who have not utilized the “Website Custom Audience” ad-based product. The “Website Custom Audience” ad-based product offers the service of automatically presenting advertisements for products that a user has looked at on the advertiser's website. An advertisement rule could be established stating that for all advertisers who have not used the Website Custom Audience product, it is recommended that they utilize the product. The advertisement recommendation 320, labeled “Lookalike Audience,” offers the service of automatically advertising to users who have a user profile similar to user profiles of previous customers of the advertiser. The advertisement recommendation 330, labeled “Video Poster,” offers a video advertisement posting service. Although FIG. 3 shows a few examples of ad-based products that may be recommended by advertisement recommendations, it should be clear that numerous variations are possible.

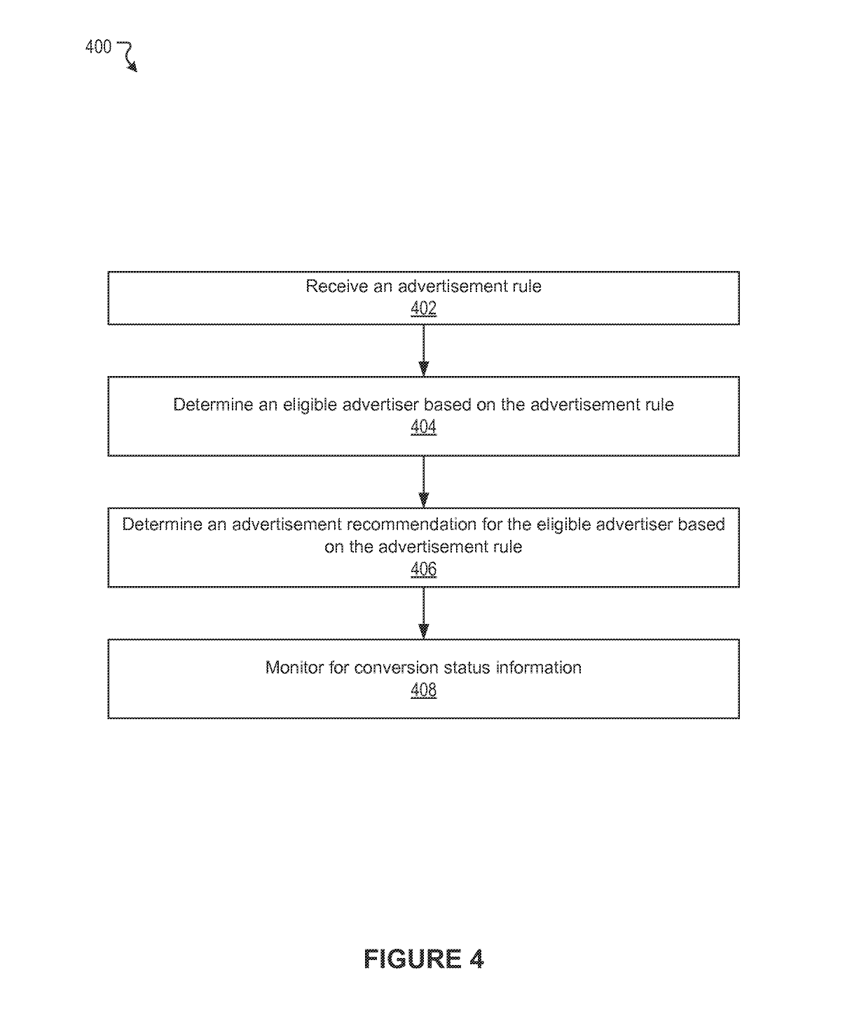

FIG. 4 illustrates an example method 400 associated with providing advertisement recommendations, according to an embodiment of the present disclosure. It should be appreciated that there can be additional, fewer, or alternative steps performed in similar or alternative orders, or in parallel, based on the various features and embodiments discussed herein unless otherwise stated.

At block 402, the example method 400 can receive an advertisement rule. At block 404, the example method 400 can determine an eligible advertiser based on the advertisement rule. At block 406, the example method 400 can determine an advertisement recommendation for the eligible advertiser based on the advertisement rule. At block 408, the example method 400 can monitor for conversion status information.

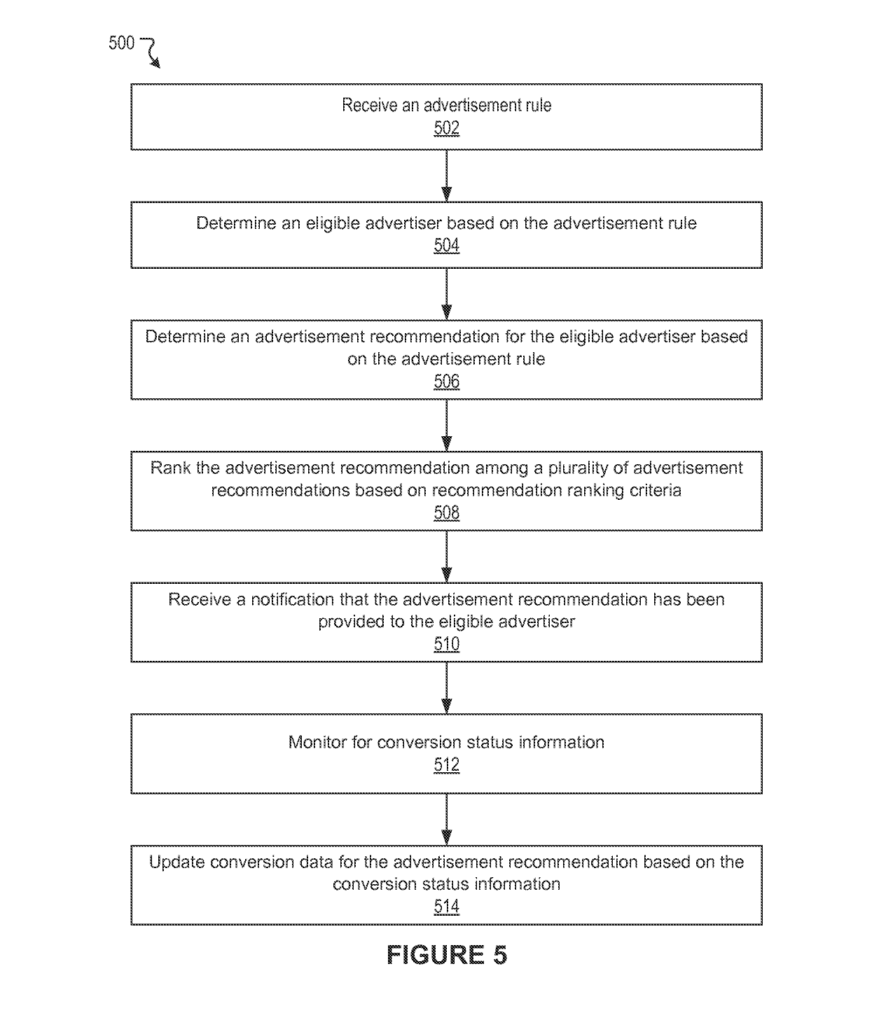

FIG. 5 illustrates an example method 500 associated with determining and ranking advertisement recommendations, according to an embodiment of the present disclosure. It should be appreciated that there can be additional, fewer, or alternative steps performed in similar or alternative orders, or in parallel, based on the various features and embodiments discussed herein unless otherwise stated.

At block 502, the example method 500 can receive an advertisement rule. At block 504, the example method 500 can determine an eligible advertiser based on the advertisement rule. At block 506, the example method 500 can determine an advertisement recommendation for the eligible advertiser based on the advertisement rule. At block 508, the example method 500 can rank the advertisement recommendation among a plurality of advertisement recommendations based on recommendation ranking criteria. At block 510, the example method 500 can receive a notification that the advertisement recommendation has been provided to the eligible advertiser. At block 512, the example method 500 can monitor for conversion status information. At block 514, the example method 500 can update conversion data for the advertisement recommendation based on the conversion status information.

### Social Networking System—Example Implementation

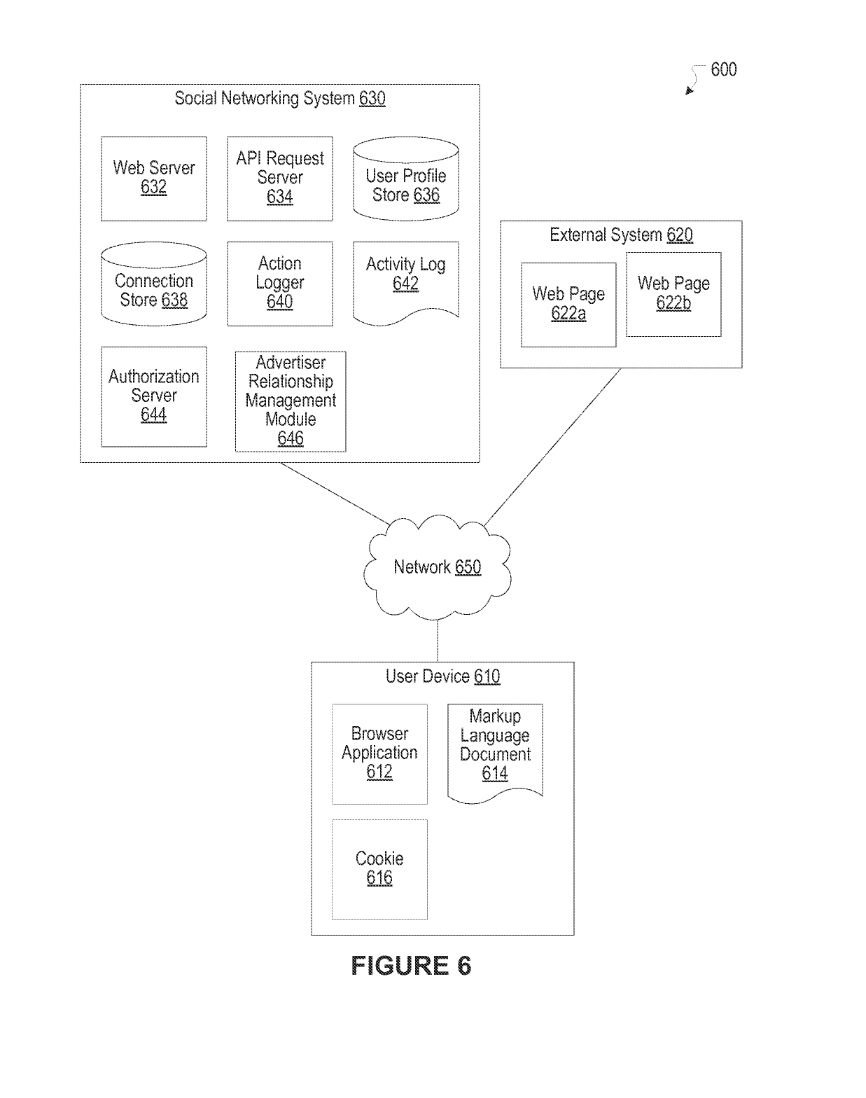

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an advertiser relationship management module 646. The advertiser relationship management module 646 can, for example, be implemented as the advertiser relationship management module 102, as discussed in more detail herein. As discussed previously, it should be appreciated that there can be many variations or other possibilities. For example, in some embodiments, one or more functionalities of the advertiser relationship management module 646 can be implemented in the user device 610.

### Hardware Implementation

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, an advertisement rule;
determining, by the computing system, an eligible advertiser based on the advertisement rule;
determining, by the computing system, an advertisement recommendation for the eligible advertiser based on the advertisement rule; and
monitoring, by the computing system, the eligible advertiser for conversion status information.

2. The computer-implemented method of claim 1, further comprising ranking the advertisement recommendation among a plurality of advertisement recommendations based on recommendation ranking criteria.

3. The computer-implemented method of claim 2, wherein each advertisement recommendation is associated with a recommendation priority score.

4. The computer-implemented method of claim 3, wherein the ranking the advertisement recommendation among a plurality of advertisement recommendations based on recommendation ranking criteria comprises ranking the advertisement recommendation among a plurality of advertisement recommendations based on the recommendation priority score.

5. The computer-implemented method of claim 3, wherein the recommendation priority score is based on an expected monetary value calculation.

6. The computer-implemented method of claim 5, wherein the expected monetary value calculation comprises the product of a probability of adoption and an expected spend amount.

7. The computer-implemented method of claim 6, wherein the expected spend amount is based on a twenty-eight day spend.

8. The computer-implemented method of claim 1, further comprising updating conversion data associated with the advertisement recommendation based on the conversion status information.

9. The computer-implemented method of claim 8, wherein updating conversion data associated with the advertisement recommendation based on the conversion status information comprises crediting the advertisement recommendation for a particular advertiser action if the particular advertiser action takes place within a pre-determined period of time after the advertiser is presented with the advertisement recommendation.

10. The computer-implemented method of claim 1, wherein the advertisement recommendation comprises a recommendation for an ad-based product offered by a social networking system.

11. A system comprising:
at least one processor; and
a memory storing instructions that, when executed by the at least one processor, cause the system to perform a method comprising:
receiving an advertisement rule;
determining an eligible advertiser based on the advertisement rule;
determining an advertisement recommendation for the eligible advertiser based on the advertisement rule; and
monitoring the eligible advertiser for conversion status information.

12. The system of claim 11, wherein the method further comprises ranking the advertisement recommendation among a plurality of advertisement recommendations based on recommendation ranking criteria.

13. The system of claim 12, wherein each advertisement recommendation is associated with a recommendation priority score.

14. The system of claim 13, wherein the ranking the advertisement recommendation among a plurality of advertisement recommendations based on recommendation ranking criteria comprises ranking the advertisement recommendation among a plurality of advertisement recommendations based on the recommendation priority score.

15. The system of claim 13, wherein the recommendation priority score is based on an expected monetary value calculation.

16. A non-transitory computer-readable storage medium including instructions that, when executed by at least one processor of a computing system, cause the computing system to perform a method comprising:
receiving an advertisement rule;
determining an eligible advertiser based on the advertisement rule;
determining an advertisement recommendation for the eligible advertiser based on the advertisement rule; and
monitoring the eligible advertiser for conversion status information.

17. The non-transitory computer-readable storage medium of claim 16, wherein the method further comprises ranking the advertisement recommendation among a plurality of advertisement recommendations based on recommendation ranking criteria.

18. The non-transitory computer-readable storage medium of claim 17, wherein each advertisement recommendation is associated with a recommendation priority score.

19. The non-transitory computer-readable storage medium of claim 18, wherein the ranking the advertisement recommendation among a plurality of advertisement recommendations based on recommendation ranking criteria comprises ranking the advertisement recommendation among a plurality of advertisement recommendations based on the recommendation priority score.

20. The non-transitory computer-readable storage medium of claim 16, wherein the recommendation priority score is based on an expected monetary value calculation.
